(19) United States
(12) Patent Application Publication
(10) Pub. No.: US 2004/0089374 A1
(43) Pub. Date: May 13, 2004

(54) E-Z funnel Jr. for riding lawn mowers

(76) Inventors: Billy W. Smith, Ethridge, TN (US); Joyce Smith, Ethridge, TN (US)

Correspondence Address: BILLY W. SMITH, P.O. Box 199, Ethridge, TN, 38456, US

(21) Appl. No.: 10/666,935

(22) Filed: Oct. 30, 2002

(51) Int. Cl. B67C 11/04

(52) U.S. Cl. 141/331

(57) ABSTRACT

A funnel (1) designed for providing accommodations for the consumer. By drilling a hole (3) through the center of the gas cap (2) the funnel can be inserted into the gas cap. The two pieces can now be put together and attached permanently with epoxy glue that is nonsoluble. A user of this funnel can now screw it onto the gas tank of their riding lawn mower and with it's special feature, the gas goes right into the tank. Their hands are free to hold the container they are using to carry the gas in.

### BACKGROUND

This invention relates to gas funnels, specifically to such funnels which are used to screw onto the mower's gas tank.

Super markets and hardware stores supply customers with plastic and tin funnels. Such funnels are used to fill riding lawn mower gas tanks. Or there are the gas containers that have a plastic spout on them for such purposes.

I have found it hard for the elderly and for myself to hold a full gas can and use one hand to get the spout in the gas tank hole or with one hand hold the funnel so it doesn't dump over.

Now with E-Z Funnel Jr. you just screw it onto the gas tank on your riding lawn mower and your hands are free to hold the gas can or container you used to carry your gas in. No problem with the funnel dumping over. Just pour the gas into your riding lawn mower.

### SUMMARY

The invention, an improved funnel, as an attached gas cap to make it safer and more convenient, notwithstanding the elderly, by providing them with a tool that will permit more control of the gas, thus no spills.

### DRAWINGS

FIG. 1 shows the two parts, the funnel and gas cap.

FIG. 1A shows the two parts put together.

### REFERENCE NUMERALS IN DRAWINGS

1 funnel

2 gas cap

3 funnel location hole

### DESCRIPTION

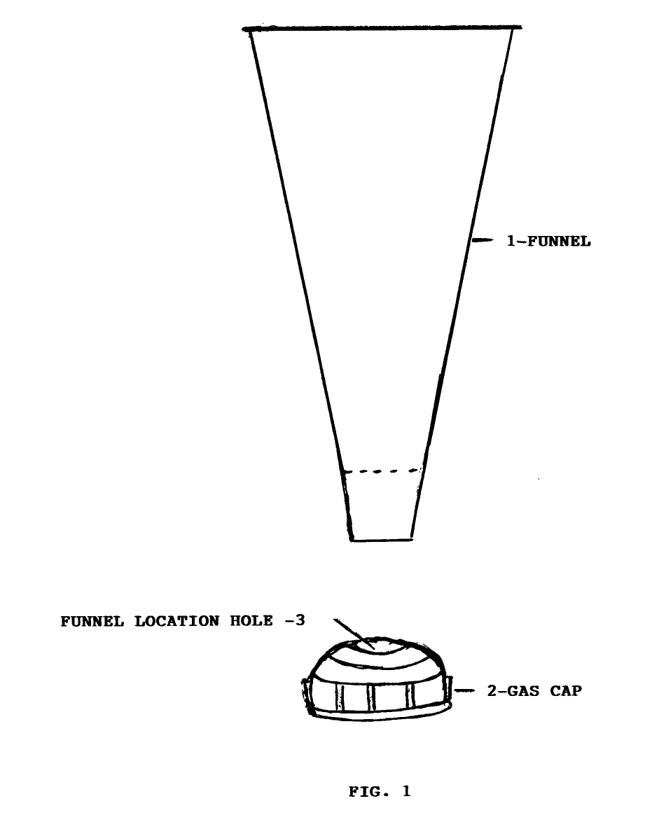

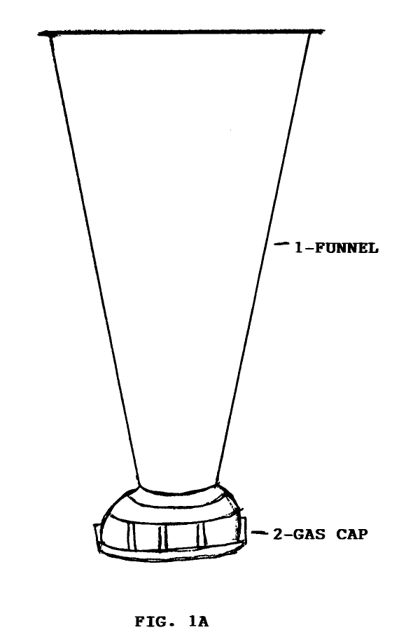

FIG. 1 is viewing the two parts of the invention showing the funnel location hole 3, which is drilled through the top of the gas cap to place the bottom of the funnel into.

FIG. 1A is viewing the two parts together using an epoxy glue to hold them in place.

1. In a funnel, comprising:
A cylinder for transferring gas from a container to the gas tank which the upper portion is a heavy duty plastic circular cone that narrows at the base. The lower portion is a durable plastic gas cap with a hole drilled through the center. The gas cap has grips around the outer side for on/off ease.
Whereas this adapted plastic cylinder, applied together with a regular sized riding lawn mower gas cap is designed to provide safety and convenience.
